(19) United States
(12) Patent Application Publication
(10) Pub. No.: US 2010/0020015 A1
(43) Pub. Date: Jan. 28, 2010

(54) MULTI-FUNCTIONAL WIRELESS MOUSE

(75) Inventor: Dae Chuel JUNG, Yongin (KR)

Correspondence Address: CANTOR COLBURN, LLP, 20 Church Street, 22nd Floor, Hartford, CT, 06103, US

(73) Assignee: IJENT CO., LTD., Seongnam (KR)

(21) Appl. No.: 12/507,180

(22) Filed: Jul. 22, 2009

(30) Foreign Application Priority Data
Jul. 22, 2008 (KR) 10-2008-0071066

(51) Int. Cl. G09G 5/08

(52) U.S. Cl. 345/163

(57) ABSTRACT

Provided is a multi-functional wireless mouse apparatus. Components for performing various functions as well as a mouse function are added to a wireless mouse and a receiver that is connected to a USB port of a computer to communicate with the wireless mouse. A digital multimedia broadcast receiving unit that can receive a digital multimedia broadcast is provided to the signal receiver. Therefore, it is possible to remove the inconvenience in that one USB port needs to be used for a general USB mouse and another USB port needs to be used for a DMB receiver. In addition, number keys and a dedicated key of which function can be designed by a user are disposed on a surface of the wireless mouse, so that the user can easily change a channel of the digital multimedia broadcast or adjust a volume.

### BACKGROUND

1. Technical Field

The present invention relates to a wireless mouse apparatus, and more particularly, to a multi-functional wireless mouse capable of receiving digital multimedia broadcast.

2. Related Art

In general, a keyboard and a mouse are used as an apparatus for inputting information to a computer. Recently, due to the development of a graphic user interface technology, a user can input information by using only the mouse. The mouse has been widely used. Much effort for removing inconvenience involved with the mouse has been made.

A wireless mouse is a representative example for removing the inconvenience. In the case where the user uses a general wired mouse is at the site that is apart from a computer main body by a long distance, the wired mouse cannot be used because of a limitation of a cable. Otherwise, a connection code needs to be used therebetween. In addition, since the wired mouse is connected to the cable, it is inconvenient to use the wired mouse.

In order to remove the inconvenience, wireless mouse apparatuses have been developed. For a conventional wireless mouse, a receiver for receiving signals generated from the wireless mouse is connected to a USB port. However, the conventional wireless mouse has a problem in that one of USB ports (for example, three or four USB ports) of the computer is always used by the receiver for the wireless mouse. Recently, various electronic apparatuses are connected to the USB ports.

As examples of the electronic apparatuses, there are a USB memory device, a USB Wibro receiver, a DMB receiver, and the like. However, since the number of USB ports is limited, such electronic apparatuses cannot be used without a limitation.

### SUMMARY

The present invention is to provide a multi-functional wireless mouse apparatus where a wireless mouse and various functions such as a DMB receiving function, a USB memory function, and a two-way wireless headphone/microphone function are integrated.

According to an aspect of the invention, there is provided a multi-functional wireless mouse apparatus comprising: a wireless mouse that transmits a mouse signal including a click signal and a position measuring signal; and a signal receiver that is connected to a computer to receive the mouse signal to output the mouse signal to the computer and to receive a digital multimedia broadcast signal to output the digital multimedia broadcast signal to the computer.

In the above aspect, the wireless mouse may comprise a key pad including number keys and a plurality of dedicated keys of which functions can be designated by a user and transmits to the signal receiver the mouse signal that further includes a key input signal of the key pad, and when the signal receiver receives the key input signal designating recording or screen-capturing of the digital multimedia broadcast input through one of the dedicated keys, the signal receiver may store the digital multimedia broadcast signal in an internal memory unit or in the computer.

In addition, the wireless mouse may convert an analog acoustic signal input from a connected microphone to a digital acoustic signal to transmit the digital acoustic signal to the signal receiver, and the wireless mouse may convert the digital acoustic signal received from the signal receiver to an analog acoustic signal to output the analog acoustic signal to a connected speaker.

In addition, the speaker and the microphone may be embedded inside a housing of the wireless mouse.

In addition, the wireless mouse may receive an auxiliary mouse signal input from a connected auxiliary mouse and a key input signal input from a connected keyboard to transmit the mouse signal generated from the wireless mouse, the auxiliary mouse signal, and the key input signal to the signal receiver, and the signal receiver may transmit the mouse signal of the wireless mouse received from the wireless mouse together with the auxiliary mouse signal and the key input signal to the computer.

In addition, the signal receiver may comprise: a multimedia broadcast receiving unit that receives the digital multimedia broadcast signal and decodes the digital multimedia broadcast signal to output an image signal and an acoustic signal; a second transceiving unit that communicates with the wireless mouse; and a receiver control unit that controls functions of the multimedia broadcast receiving unit and transmits the image signal and the acoustic signal of the multimedia broadcast to the computer so that the computer can output the image signal and the acoustic signal, and the wireless mouse may comprise: a position measuring unit that measures a position of the wireless mouse and outputs a position measuring signal; an input unit that generates the click signal and a scroll signal according to user's manipulation; a first transceiving unit that communicates with the signal receiver; and a mouse control unit that controls the position measuring unit, the input unit, and the first transceiving unit and transmits the mouse signal including the position measuring signal, the click signal, and the scroll signal through the first transceiving unit to the signal receiver.

In addition, the input unit may further generate a key input signal of a key pad that is provided to the wireless mouse, and the mouse control unit may transmit to the signal receiver the mouse signal that further includes the key input signal.

In addition, the wireless mouse may further comprise an acoustic signal input/output unit that converts an analog acoustic signal input from a connected microphone to a digital acoustic signal, outputs the digital acoustic signal to the mouse control unit, converts the digital acoustic signal received from the mouse control unit to an analog acoustic signal, and outputs the analog acoustic signal to a connected speaker, and the mouse control unit may output the digital acoustic signal received from the signal receiver to the acoustic signal input/output unit and transmit the digital acoustic signal received from the acoustic signal input/output unit to the signal receiver.

In addition, the wireless mouse may further comprise a first extension unit that receives an auxiliary mouse signal input from a connected auxiliary mouse and a key input signal input from a connected keyboard to output the signals to the mouse control unit, and the mouse control unit may transmit the auxiliary mouse signal and the key input signal together with the mouse signal generated from the wireless mouse to the signal receiver.

In addition, the signal receiver may further comprise a second extension unit that connects an external electronic apparatus to the computer through the receiver control unit in a USB or IEEE 1394 scheme.

In addition, the signal receiver may further comprise a memory unit that stores a driver program of the multi-functional wireless mouse apparatus, and when the signal receiver is connected to the computer, the receiver control unit may check whether or not the driver program is installed in the computer, and if the driver program is not installed, the receiver control unit may transmit the driver program to the computer to install the driver program in the computer.

In the invention, components for performing various functions as well as a mouse function are added to the wireless mouse and the receiver that is connected to the USB port of the computer to communicate with the wireless mouse.

In the invention, the digital multimedia broadcast receiving unit that can receive the digital multimedia broadcast is provided to the signal receiver. Therefore, it is possible to remove the inconvenience in that one USB port needs to be used for the general USB mouse and another USB port needs to be used for the DMB receiver.

In addition, in the invention, number keys and a dedicated key of which function can be designed by the user are disposed on a surface of the wireless mouse, so that the user can easily change a channel of the digital multimedia broadcast or adjust a volume.

In addition, in the invention, the signal receiver includes a memory unit that can store a driver program or user's data, so that it can be checked whether or not the driver program is installed every time when the wireless mouse is connected to the computer. If not installed, the driver program is automatically installed, so that it is possible to remove the inconvenience in that a separate program CD for the installation is to be carried. In addition, the user can record or store the digital multimedia broadcast or other required data in the memory unit inside the signal receiver without user's separately carrying a USB memory device.

In addition, in the invention, the microphone and the speaker can be connected to the wireless mouse, so that the music and the broadcast can be listened and viewed without any speaker and microphone connected to the computer and the user can record user's voice.

In addition, in the invention, the auxiliary mouse and the keyboard can be connected to the wireless mouse, so that the limited number of the USB ports of the computer can be efficiently used in a wireless manner.

### BRIEF DESCRIPTION OF THE DRAWINGS

The invention will be described with reference to the accompanying drawings, wherein like numbers reference like elements.

FIG. 1 is a view showing a multi-functional wireless mouse apparatus according to a first embodiment of the invention.

FIG. 2 is a detailed block diagram showing a detailed configuration of a signal receiver and a wireless mouse according to the first embodiment of the invention.

FIG. 3 is a view showing a configuration of a multi-functional wireless mouse apparatus according to a second embodiment of the invention.

FIG. 4 is a detailed block diagram showing a detailed configuration of a signal receiver and a wireless mouse according to the second embodiment of the invention.

### DESCRIPTION OF EXEMPLARY EMBODIMENTS

Hereinafter, exemplary embodiments of the invention will be described with reference to the accompanying drawings.

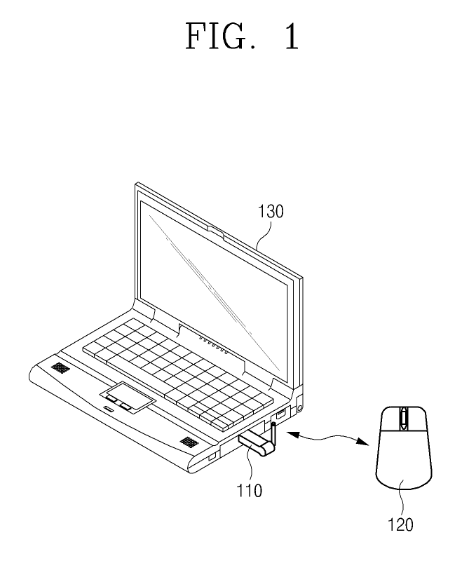

FIG. 1 is a view showing a multi-functional wireless mouse apparatus according to a first embodiment of the invention. Referring to FIG. 1, the multi-functional wireless mouse apparatus according to the first embodiment of the invention includes a wireless mouse 120 and a signal receiver 110.

Similarly to a general wireless mouse, the wireless mouse 120 transmits a mouse input signal to the signal receiver 110.

The signal receiver 110 is connected to a desktop computer, a notebook computer, a PDA, or the like (hereinafter, referred to as a computer 130) in a USB or IEEE 1394 scheme. The signal receiver 110 receives the mouse input signal from the wireless mouse 120 and decodes the mouse input signal to output the mouse input signal to the computer 130. In addition, the signal receiver 110 receives a digital multimedia broadcast signal (hereinafter, referred to as a broadcast signal) such as a DMB signal or an 1SEG signal and decodes the digital multimedia broadcast signal to output the digital multimedia broadcast signal to the computer 130.

The computer 130 connected to the signal receiver 110 receives the decoded broadcast signal and outputs the decoded broadcast signal to a user. In addition, the computer 130 performs inputting data by using the mouse input signal received from the wireless mouse 120.

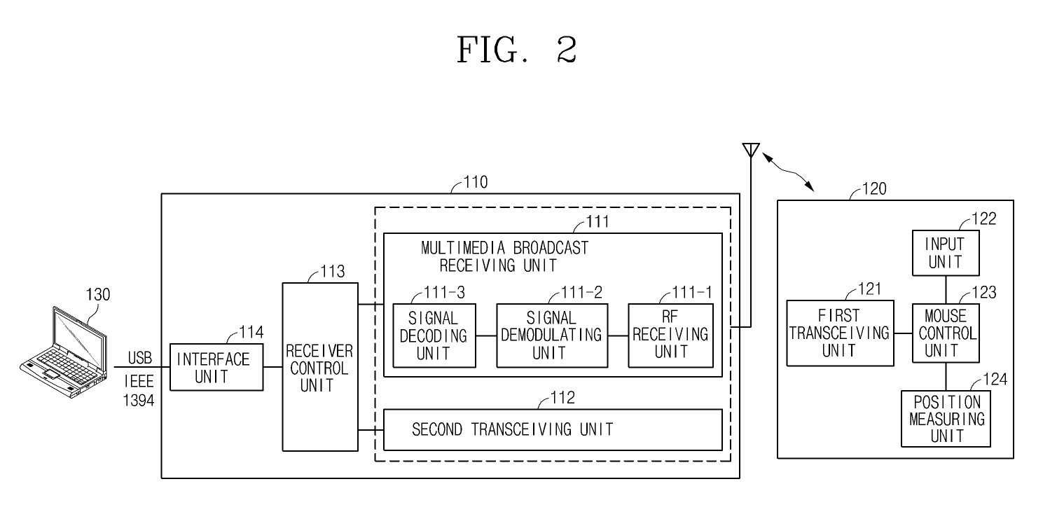

FIG. 2 is a detailed block diagram showing a detailed configuration of the signal receiver 110 and the wireless mouse 120 according to the first embodiment of the invention.

Referring to FIG. 2, the wireless mouse 120 includes an input unit 122, a position measuring unit 124, a first transceiving unit 121, and a mouse control unit 123.

The input unit 122 is constructed with buttons, a wheel, and the like of a general wireless mouse. The input unit 122 receives user's click and scroll signals to output the signals to the mouse control unit 123. The position measuring unit 124 measures the motion of the wireless mouse 120 to output a position measuring signal to the mouse control unit 123.

In addition, the first transceiving unit 121 wirelessly transmits the button signal, the scroll signal, and the position measuring signal in a predetermined frequency band (in the embodiment of the invention, 2.4 GHz, 5.8 GHz, or the like). The mouse control unit 123 outputs the signals input from the input unit 122 and the position measuring unit 124 to the first transceiving unit 121. In addition, the mouse control unit 123 controls functions of the input unit 122, the position measuring unit 124, and the first transceiving unit 121. Since the functions of the wireless mouse 120 according to the first embodiment are similar to those of a general wireless mouse, detailed description thereof is omitted.

In addition, the signal receiver 110 includes a multimedia broadcast receiving unit 111, a second transceiving unit 112, an interface unit 114, and a receiver control unit 11. The multimedia broadcast receiving unit 111 includes an RF receiving unit 111-1, a signal demodulating unit 111-2, and a signal decoding unit 111-3.

Firstly, the case where the multimedia broadcast receiving unit 111 receives the DMB broadcast signal is exemplarily described. The multimedia broadcast receiving unit 111 receives a terrestrial DMB broadcast signal or a satellite DMB broadcast signal to output the DMB broadcast signal to the receiver control unit 113. More specifically, the RF receiving unit 111-1 of the multimedia broadcast receiving unit 111 receives user's selected channel signal among the digital multimedia broadcast signals (multiplexed broadcast signals) broadcasted from a satellite DMB station or a terrestrial DMB station to output the signal to the signal demodulating unit 111-2.

The signal demodulating unit 111-2 converts an analog broadcast signal received from the RF receiving unit 111-1 to a digital signal and performs OFDM decoding to output a decoded signal to the signal decoding unit 111-3.

The signal decoding unit 111-3 performs convolution interleaving and RS decoding on the signals received from the signal demodulating unit 111-2 to generate an MPEG-2 TS stream. The signal decoding unit 111-3 performs demultiplexing the MPEG-2 TS stream. A video signal is decoded according to the H.264 scheme, so that an image signal is output to the receiver control unit 113. An audio signal is decoded according to the BSAC codex scheme, so that an acoustic signal is output to the receiver control unit 113.

The second transceiving unit 112 receives the mouse signal from the wireless mouse 120 in a predetermined frequency band (in the embodiment of the invention, 2.4 GHz, 5.8 GHz, or the like) to output the mouse signal to the receiver control unit 113.

The receiver control unit 113 controls the entire functions of the signal receiver 110 to output the image signal and the acoustic signal input from the multimedia broadcast receiving unit 111 through the interface unit 114 to the computer 130, so that the signals can be displayed to the user. In addition, the receiver control unit 113 transmits the mouse signal input from the second transceiving unit 112 through the interface unit 114 to the computer 130.

The interface unit 114 transmits the DMB signal (image signal and acoustic signal) and the mouse signal input from the receiver control unit 113 in the USB or IEEE 1394 scheme to the computer 130. The interface unit 114 outputs the control signal input from the computer 130 to the receiver control unit 113.

Hereinbefore, the multi-functional wireless mouse apparatus according to the first embodiment of the invention is described. According to the multi-functional wireless mouse apparatus of the first embodiment, the wireless mouse function and the multimedia broadcast receiving function can be simultaneously performed by using a single USB or IEEE 1394 port.

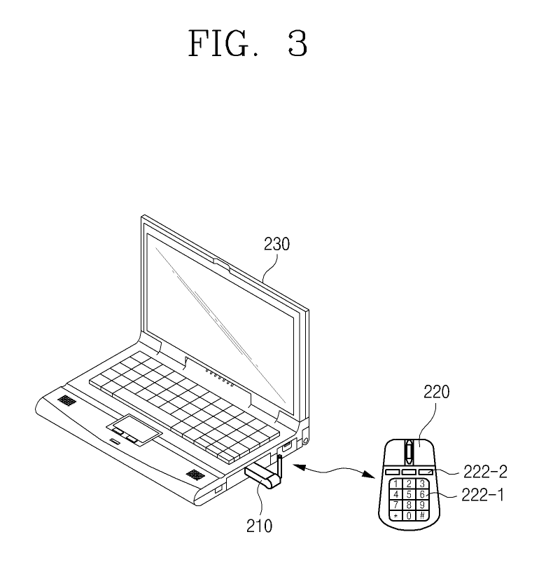

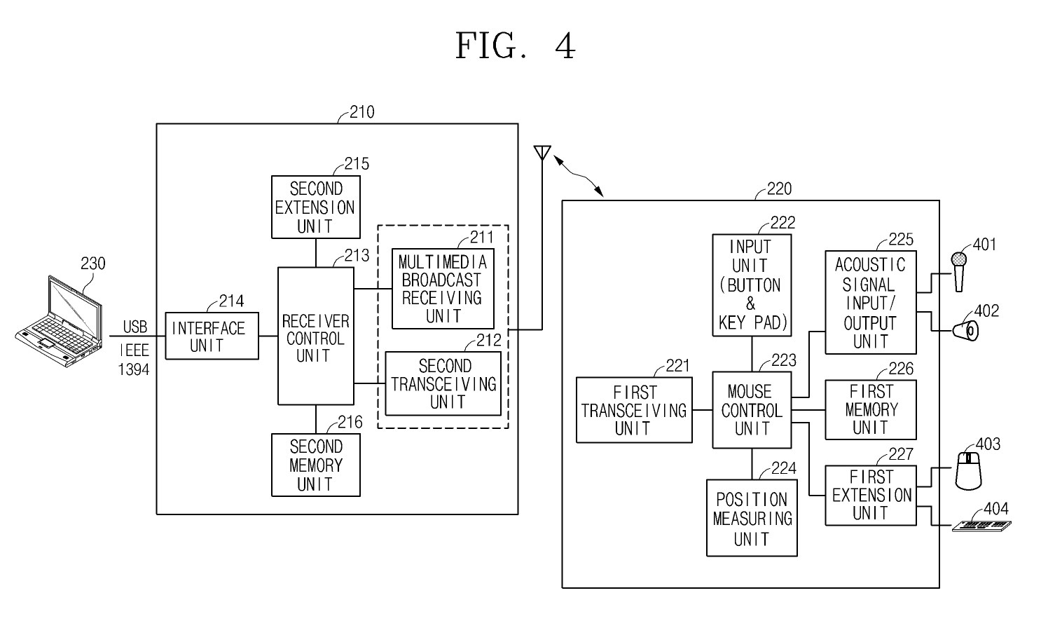

FIG. 3 is a view showing a configuration of a multi-functional wireless mouse apparatus according to a second embodiment of the invention. FIG. 4 is a detailed functional block diagram of the second embodiment of the invention. The multi-functional wireless mouse apparatus according to the second embodiment further includes an external memory function, a microphone/speaker connecting function, a key pad input function, a digital multimedia broadcast recording function, an auxiliary mouse/keyboard connecting function, and the like as well as the functions of the mouse apparatus according to the first embodiment.

Referring to FIGS. 3 and 4, the wireless mouse 220 according to the second embodiment includes an input unit 222, a position measuring unit 224, a first transceiving unit 221, a mouse control unit 223, an acoustic signal input/output unit 225, a first memory unit 226, and a first extension unit 227.

As well as the buttons and the wheel of the general wireless mouse, the input unit 222 is further provided with a key pad 222-1 through which the user can easily input numbers and special characters, a dedicated key 222-1 through which the user can easily record or screen-capture the digital multimedia broadcast, and an auxiliary key 222-2 which the user can use by designating a function. Therefore, the input unit 222 receives the user's click, scroll, and key input signals to output the signals to the mouse control unit 223.

The position measuring unit 224 measures the motion of the wireless mouse 220 and outputs the position measuring signal to the mouse control unit 223.

The acoustic signal input/output unit 225 converts a digital audio signal input from the mouse control unit 223 to an analog signal and amplifies the analog signal to output the amplified analog signal to the speaker 402 connected to the acoustic signal input/output unit 225. In addition, the acoustic signal input/output unit 225 converts an analog acoustic signal input from the microphone 401 connected to the acoustic signal input/output unit 225 to a digital signal to output the digital signal to the mouse control unit 223.

In FIG. 4, a separate speaker 402 and a separate microphone 401 are connected to the acoustic signal input/output unit 225. Alternatively, the speaker 402 and the microphone 401 may be embedded inside an outer housing of the wireless mouse.

The first memory unit 226 performs the same functions as a general external memory device. The first memory unit stores data that are to be used by the user such as user's authorized certificate, VoIP phone authentication, and other data. More specifically, under the control of the mouse control unit 223, the first memory unit 226 performs functions of storing the data, reading out the stored data, and outputting the data to the mouse control unit 223. The functions between the first memory unit 226 and the mouse control unit 223 are the same as those between the control unit of the USB memory device and the flash memory, and thus, detailed description thereof is omitted.

The first extension unit 227 performs functions of connecting external electronic apparatuses to the mouse control unit 223 such as the functions of the one or more USB or IEEE 1394 ports. In the embodiment of the invention, the user connects the USB keyboard 404, the USB mouse 403, and the like to the first extension unit 227, so that the user can use the additional mouse 403 together with the wireless mouse 220 according to the invention or the user can use the wireless mouse 220 and the keyboard 404 simultaneously. In addition, the user can connect an electronic apparatus such as a PMP and a PDA.

In addition, the first transceiving unit 221 wirelessly communicates with the second transceiving unit 212 of the signal receiver 210 in a predetermined frequency band (in the embodiment of the invention, 2.4 GHz, 5.8 GHz, or the like) to transmit various signals input from the mouse control unit 223 to the second transceiving unit 212 of the signal receiver 210 and to receive the control signals and the data generated by the signal receiver 210 from the second transceiving unit 212 to output the signals and data to the mouse control unit 223.

The mouse control unit 223 controls the function of the aforementioned components. More specifically, the mouse control unit 223 receives the button, scroll, and key input signals input from the input unit 222 and the position measuring signal of the wireless mouse 220 input from the position measuring unit 224 to output the signals to the first transceiving unit 221.

In addition, the mouse control unit 223 outputs the digital audio signal that is received from the signal receiver 210 according to a predetermined protocol to the acoustic signal input/output unit 225. The mouse control unit 223 outputs the digital audio signal through the speaker 402 to the user. The mouse control unit 223 receives the acoustic signal input through the microphone 401 from the acoustic signal input/output unit 225 to output the acoustic signal to the first transceiving unit 221 so that the acoustic signal is transmitted to the signal receiver 210 according to a predetermined protocol. In the embodiment of the invention, the transmission scheme for the audio data (sometimes, referred to as acoustic data) is the I2S protocol. However, it should be noted that the invention is not limited to a specific protocol.

In addition, the mouse control unit 223 receives signals of the electronic apparatus such as the mouse 403 and the keyboard 404 connected to the first extension unit 227 to transmit the signals to the signal receiver 210. The mouse control unit 223 receives the control signals of the electronic apparatus from the signal receiving unit to output the control signals through the first extension unit 227 to a connected electronic apparatus.

In addition, the signal receiver 210 according to the second embodiment of the invention includes a multimedia broadcast receiving unit 211, a second transceiving unit 212, an interface unit 214, a receiver control unit 213, a second extension unit 215, and a second memory unit 216.

Since the functions of the multimedia broadcast receiving unit 211, the second transceiving unit 212, and the interface unit 214 are the same as those of the aforementioned first embodiment, detailed description thereof is omitted.

Similarly to the first memory unit 226, the second memory unit 216 stores data that are to be used by the user, a driver program for driving the signal receiver 210 and the wireless mouse 220 according to the invention, a recorded broadcast received by the multimedia broadcast receiving unit 211, and a screen obtained by capturing the broadcast.

Similarly to the first extension unit 227, the second extension unit 215 is implemented with one or more USB or IEEE 1394 ports to connect a USB memory device, a keyboard, a mouse, a PMP, a PDA, and other electronic apparatuses to the receiver control unit 213. The connected electronic apparatuses can be controlled by the computer 230.

The receiver control unit 213 controls components of the signal receiver 210 and outputs the image signal and the acoustic signal input from the multimedia broadcast receiving unit 211 through the interface unit 214 to the computer 230 so that the signals can be displayed to the user. In addition, the receiver control unit 213 transmits the mouse signal input from the second transceiving unit 212 through the interface unit 214 to the computer 230.

In addition, if the receiver control unit 213 is connected through the interface unit 214 to the computer 230, the receiver control unit 213 checks whether or not a driver program for using the multi-functional wireless mouse 220 is installed in the computer 230. If not installed, the receiver control unit 213 loads a program stored in the second memory unit 216 to install the driver program in the computer 230.

In addition, the receiver control unit 213 records broadcast received through the multimedia broadcast receiving unit 211 to store the broadcast in the second memory unit 216. The receiver control unit 213 may capture a specific screen to store the specific screen in the second memory unit 216.

Hereinbefore, the functions of the components of the wireless mouse 220 and the signal receiver 210 according to the invention are described. Now, the operations of the multi-functional wireless mouse apparatus will be described.

Firstly, in the case where the user views multimedia broadcast, the multimedia broadcast receiving unit 211 receives broadcast signals and decodes the image signal and the audio signal (acoustic signal) to output the signals to the receiver control unit 213. The receiver control unit 213 transmits these signals through the interface unit 214 to the computer 230, so that the user can view the multimedia broadcast.

At this time, in the case where the user is to record the multimedia broadcast that the user currently views, the user moves the wireless mouse 220 to click the record button displayed on the screen. The broadcast that is currently displayed to the user can be stored in the computer 230 according to user's selection or in the second memory unit 216.

In addition, in order to speedily and easily record/capture the multimedia broadcast, the user designates the recording/capturing functions to the dedicated key 222-2 provided to the wireless mouse 220 in advance. If the dedicated key 222-2 designated to the recording/capturing functions is pushed, the key input signal is output to the mouse control unit 223. The mouse control unit 223 transmits the key input signal through the first transceiving unit 221 to the signal receiver 210. The receiver control unit 213 receives the key input signal, and after that, the receiver control unit 213 stores the broadcast signal in the computer 230 or in the second memory unit 216.

In addition, the user pushes previously-defined volume key, channel select key, and the like during the viewing of the digital multimedia broadcast so as to easily adjust a volume of the broadcast or to easily change channel.

In addition, in the case where a speaker is not provided to the computer 230, the receiver control unit 213 outputs the image signal input from the multimedia broadcast receiving unit 211 to the computer 230 so that the image signal can be displayed to the user. In addition, the receiver control unit 213 transmits the acoustic signal to the wireless mouse 220 so that the acoustic signal can be output through the speaker 402 that is embedded in the wireless mouse 220 or connected to the acoustic signal input/output unit 225.

In addition, the user may connect the mouse 403 and the keyboard 404 to the first extension unit 227 of the wireless mouse 220. In this case, the mouse control unit 223 receives the input signal input through the first extension unit 227 from the mouse 403 and the keyboard 404 to transmit the input signal to the signal receiver 210. The signal receiver 210 outputs the keyboard signal and the mouse signal input from the wireless mouse 220 to the computer 230. In this case, according to the settings, the wireless mouse 220 and the mouse 403 connected to the first extension unit 227 can be simultaneously operated, or only the mouse 403 connected to the first extension unit 227 may be operated.

In addition, in the case where the user is to listen to a music through a headphone, the user connects the headphone to the acoustic signal input/output unit 225. The acoustic signal played in the computer 230 is transmitted through the signal receiver 210 to the wireless mouse 220. The mouse control unit 223 outputs the acoustic signal received according to the I2S protocol to the acoustic signal input/output unit 225. The acoustic signal input/output unit 225 converts the digital signal to the analog signal to output the analog signal to the headphone speaker 402.

In addition, in the case where the user records the audio signal by using the microphone 401, the analog acoustic signal is input from the acoustic signal input/output unit 225 through the microphone 401 connected to the acoustic signal input/output unit 225. The analog acoustic signal is converted to the digital acoustic signal. Next, the digital acoustic signal is output to the mouse control unit 223. The mouse control unit 223 transmits the input digital acoustic signal to the signal receiver 210. The signal receiver 210 stores the received acoustic signal in the second memory unit 216. Alternatively, the signal receiving unit 210 outputs the received acoustic signal to the computer 230 to store the signal therein.

In addition, in order to move the data stored in user's external memory device to the computer 230 or to move a moving picture/music file stored in the computer 230 to user's portable multimedia player (PMP), the user connects the external memory device or the PMP to the second extension unit 215. The receiver control unit 213 outputs the moving picture/music file received from the computer 230 to the PMP connected to the second extension unit 215 and stores the file. In addition, the receiver control unit 213 may output the data read out from the external memory device to the computer 230 and store the file.

As described above, the multi-functional wireless mouse apparatus according to the invention can be implemented so as to perform various functions of the USB hub, the external memory device, and the like so that the digital multimedia broadcast receiver and a plurality of the electronic apparatuses can be connected thereto.

While the invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the invention.

What is claimed is:

1. A multi-functional wireless mouse apparatus comprising:
a wireless mouse that transmits a mouse signal including a click signal and a position measuring signal; and
a signal receiver that is connected to a computer to receive the mouse signal to output the mouse signal to the computer and to receive a digital multimedia broadcast signal to output the digital multimedia broadcast signal to the computer.

2. The multi-functional wireless mouse apparatus according to claim 1,
wherein the wireless mouse comprises a key pad including number keys and a plurality of dedicated keys of which functions can be designated by a user and transmits to the signal receiver the mouse signal that further includes a key input signal of the key pad, and
wherein, when the signal receiver receives the key input signal designating recording or screen-capturing of the digital multimedia broadcast input through one of the dedicated keys, the signal receiver stores the digital multimedia broadcast signal in an internal memory unit or in the computer.

3. The multi-functional wireless mouse apparatus according to claim 1, wherein the wireless mouse converts an analog acoustic signal input from a connected microphone to a digital acoustic signal to transmit the digital acoustic signal to the signal receiver, and the wireless mouse converts the digital acoustic signal received from the signal receiver to an analog acoustic signal to output the analog acoustic signal to a connected speaker.

4. The multi-functional wireless mouse apparatus according to claim 3, wherein the speaker and the microphone are embedded inside a housing of the wireless mouse.

5. The multi-functional wireless mouse apparatus according to claim 1,
wherein the wireless mouse receives an auxiliary mouse signal input from a connected auxiliary mouse and a key input signal input from a connected keyboard to transmit the mouse signal generated from the wireless mouse, the auxiliary mouse signal, and the key input signal to the signal receiver, and
wherein the signal receiver transmits the mouse signal of the wireless mouse received from the wireless mouse together with the auxiliary mouse signal and the key input signal to the computer.

6. The multi-functional wireless mouse apparatus according to claim 1,
wherein the signal receiver comprises:
a multimedia broadcast receiving unit that receives the digital multimedia broadcast signal and decodes the digital multimedia broadcast signal to output an image signal and an acoustic signal;
a second transceiving unit that communicates with the wireless mouse; and
a receiver control unit that controls functions of the multimedia broadcast receiving unit and transmits the image signal and the acoustic signal of the multimedia broadcast to the computer so that the computer can output the image signal and the acoustic signal, and
wherein the wireless mouse comprises:
a position measuring unit that measures a position of the wireless mouse and outputs a position measuring signal;
an input unit that generates the click signal and a scroll signal according to user's manipulation;
a first transceiving unit that communicates with the signal receiver; and
a mouse control unit that controls the position measuring unit, the input unit, and the first transceiving unit and transmits the mouse signal including the position measuring signal, the click signal, and the scroll signal through the first transceiving unit to the signal receiver.

7. The multi-functional wireless mouse apparatus according to claim 6,
wherein the input unit further generates a key input signal of a key pad that is provided to the wireless mouse, and
wherein the mouse control unit transmits to the signal receiver the mouse signal that further includes the key input signal.

8. The multi-functional wireless mouse apparatus according to claim 6,
wherein the wireless mouse further comprises an acoustic signal input/output unit that converts an analog acoustic signal input from a connected microphone to a digital acoustic signal, outputs the digital acoustic signal to the mouse control unit, converts the digital acoustic signal received from the mouse control unit to an analog acoustic signal, and outputs the analog acoustic signal to a connected speaker, and
wherein the mouse control unit outputs the digital acoustic signal received from the signal receiver to the acoustic signal input/output unit and transmits the digital acoustic signal received from the acoustic signal input/output unit to the signal receiver.

9. The multi-functional wireless mouse apparatus according to claim 6,
wherein the wireless mouse further comprises a first extension unit that receives an auxiliary mouse signal input from a connected auxiliary mouse and a key input signal input from a connected keyboard to output the signals to the mouse control unit, and
wherein the mouse control unit transmits the auxiliary mouse signal and the key input signal together with the mouse signal generated from the wireless mouse to the signal receiver.

10. The multi-functional wireless mouse apparatus according to claim 6, wherein the signal receiver further comprises a second extension unit that connects an external electronic apparatus to the computer through the receiver control unit in a USB or IEEE 1394 scheme.

11. The multi-functional wireless mouse apparatus according to claim 6,
wherein the signal receiver further comprises a memory unit that stores a driver program of the multi-functional wireless mouse apparatus, and
wherein, when the signal receiver is connected to the computer, the receiver control unit checks whether or not the driver program is installed in the computer, and if the driver program is not installed, the receiver control unit transmits the driver program to the computer to install the driver program in the computer.
